(19) United States
(12) Patent Application Publication
(10) Pub. No.: US 2009/0222364 A1
(43) Pub. Date: Sep. 3, 2009

(54) SYSTEM AND METHOD FOR ATTRIBUTE-BASED TRANSACTION CATEGORIZATION

(75) Inventors: Joseph A. McGlynn, Highlands Ranch, CO (US); Conor Keane, Englewood, CO (US)

Correspondence Address: HENSLEY KIM & HOLZER, LLC, 1660 LINCOLN STREET, SUITE 3000, DENVER, CO, 80264, US

(73) Assignee: Ourcashflow.com, LLC, Denver, CO (US)

(21) Appl. No.: 12/352,012

(22) Filed: Jan. 12, 2009

Related U.S. Application Data
(60) Provisional application No. 61/032,578, filed on Feb. 29, 2008.

(51) Int. Cl. G06Q 40/00; G06Q 10/00

(52) U.S. Cl. 705/30

(57) ABSTRACT

Presently disclosed is a system for attribute-based transaction categorization that utilizes transaction designation attributes other than or in addition to a payee name to provide reduced user effort and improved accuracy in the categorization of transactions. Further, the system for transaction categorization may retroactively re-categorize and/or re-name previous transactions based on subsequent transaction categorization. The transaction categorization system may assign match scores based on the number and/or type of designation attributes that match rules for associating a designation to a transaction. If a match score exceeds a predetermined threshold and/or is greater than other match scores, the transaction is automatically designated. Otherwise, the user may manually designate the transaction. Manually designated transactions may be used by the transaction categorization system to generate new designation rules.

### CROSS REFERENCE

This application claims the benefit of U.S. Provisional Application No. 61/032,578 filed Feb. 29, 2008 entitled “System and Method for Community-Based Transaction Categorization,” the content of which is hereby incorporated by reference in its entirety.

### BACKGROUND

A major challenge in helping users get value from Personal Financial Management (PFM) systems is reducing or overcoming the administrative effort involved in obtaining meaningful financial advice from the PFM system. Today's popular PFM applications require extensive user effort to set up the PFM system and continued user effort to ensure day to day user spending is recorded and analyzed accurately.

Conventional PFM systems utilizing transaction categorization typically allow the user to manually assign a category to each transaction for budget analysis. Some conventional PFM systems store the categorization that the user associated with a merchant and apply that same categorization to all future transactions with that same merchant. Similarly, conventional PFM systems typically allow the user to manually edit a merchant name to be used later for budget analysis. Further, some conventional PFM systems utilize a database that stores common category and/or merchant name associations for known merchants, and these systems apply those associations by default unless the user specifies otherwise.

### TECHNICAL FIELD

The subject matter discussed herein relates to systems and methods for attribute-based transaction categorization.

### SUMMARY

Presently disclosed is a system for attribute-based transaction categorization (hereinafter transaction categorization) that utilizes transaction designation attributes other than or in addition to a payee name (e.g. a merchant name) to provide reduced user effort and improved accuracy in the categorization of transactions. Further, the transaction categorization system may retroactively re-categorize and/or re-name previously received and/or categorized transactions based on transaction categorizations of subsequently received and/or categorized transactions.

Transaction categorization collects transaction attributes and uses them to take much of the user effort out of managing user finances by automatically categorizing recognized transactions. More specifically, the transaction categorization system has access to designation rules associating attributes of transactions other than or in addition to payee name with transaction designations, such as categories and transaction names. The transaction categorization system uses these designation rules to automatically associate designations to individual transactions.

In one implementation, the transaction categorization system may assign match scores based on the number and/or type of designation attributes that match rules for associating a designation to a transaction. If a match score exceeds a predetermined threshold and/or is greater than other match scores (i.e. the best match score), the transaction is automatically designated. Otherwise, the user may manually designate the transaction.

In another implementation, the user may manually generate rules, categories, and/or transaction names for transaction designation. Further, the user may manually designate transactions and the transaction categorization system can use the manually designated transactions to generate new designation rules. Still further, the transaction categorization system can retroactively re-categorize and/or re-name previous transactions based on new rules generated by the transaction categorization system based on manually designated transactions.

### BRIEF DESCRIPTION OF THE DRAWINGS

FIG. 1 illustrates an example attribute-based transaction categorization system operating over a network in accordance with one implementation of the presently disclosed technology.

FIG. 2 illustrates an example attribute-based transaction categorization system with multiple users and commercial entities operating over a network in accordance with one implementation of the presently disclosed technology.

FIG. 3 is an attribute-based transaction categorization flowchart illustrating an algorithm for associating a transaction designation according to one implementation.

FIG. 4 is an attribute-based transaction categorization flowchart illustrating an algorithm for associating a transaction designation according to another implementation.

FIGS. 5-7 are screenshots of example user interfaces for use in an attribute-based transaction categorization system according to various implementations of the presently disclosed technology.

FIG. 8 illustrates a general purpose computer upon which components and functionality of implementations may be implemented.

### DETAILED DESCRIPTION

Attribute-based transaction categorization (hereinafter transaction categorization) takes much of the user effort out of personal financial management by automatically categorizing transactions for a user. From the moment the user accesses the transaction categorization system; his/her effort is focused on understanding their budget, reviewing their spending, making decisions on how to meet goals, and determining whether any changes should be made in their behavior manually categorizing each of his/her transactions. With implementations of the presently disclosed technology, users have more time to understand their finances and use the benefits of a corresponding Personal Financial Management (PFM) application (e.g., budgeting, financial analysis, and decision making). As a result, the PFM application accordingly to the presently disclosed technology is more beneficial to the user than a conventional PFM application.

Transaction categorization, referred to throughout this disclosure, contemplates static designations (e.g. the designation of financial categories to transactions and designation of abbreviated or customized names for transactions with a common payee). Further, transaction designation also contemplates dynamic designations, designations that alter the characteristics of a transaction attribute. For example, truncation of various features of a payee field of a transaction and payee field feature look-up in a feature database based on transaction attributes). Further, any other designations that a user may make or want a PFM system to make to help organize and analyze the user's financial transactions are contemplated herein.

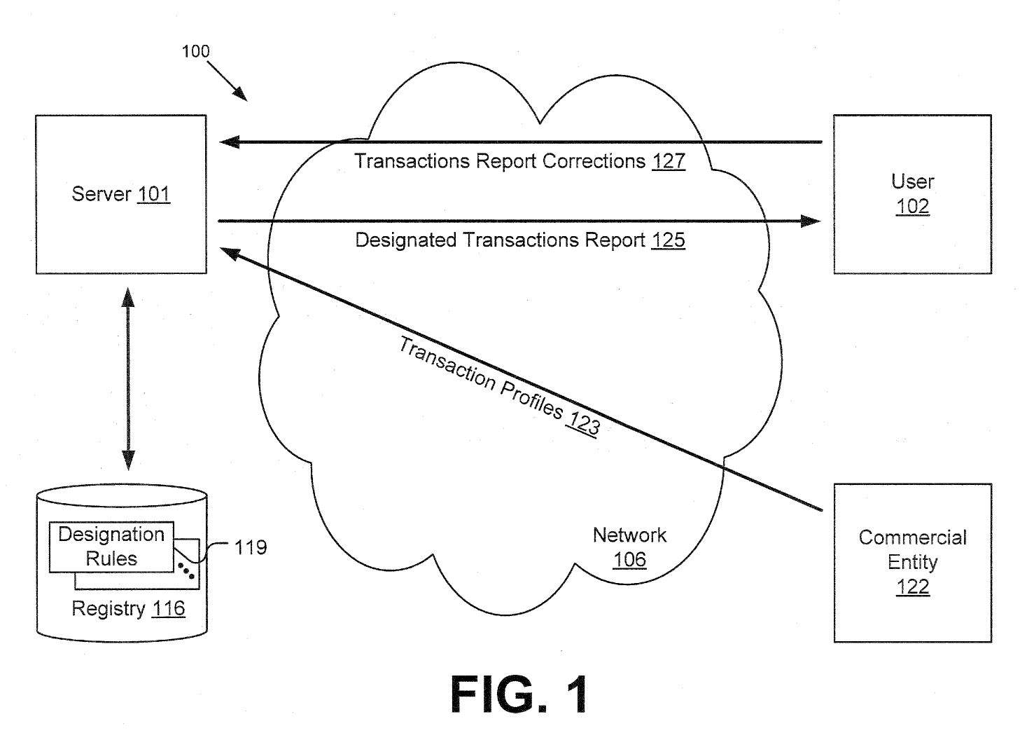

FIG. 1 illustrates an example transaction categorization system 100 operating over a network 106 in accordance with one implementation of the presently disclosed technology. A commercial entity 122 (e.g., banks, stores, restaurants, etc.) is in communication with and submits transaction profiles 123 associated with a user 102 to a transaction categorization server 101 via a wireline connection, wireless connection, or any combination thereof Transaction profiles 123 include transaction attributes describing a transaction, including, but not limited to, payee name, transaction description, transaction date, transaction amount, transaction type code, account type, payment method, recurrence period, recurrence time, demographic information, match count, and select count.

In one implementation, the server 101 periodically accesses a server associated with the commercial entity 122, the server then downloads the transaction profiles 123 associated with the user 102 from the commercial entity 122. Designation rules 119 stored in a registry 116 are applied to the transaction profiles 123 and the results are compiled in a designated transactions report 125 sent to the user 102. Optionally, the user 102 may respond with transaction report corrections 127 if the designated transactions report 125 is incomplete or incorrect.

The transaction categorization server 101 is in operable communication with a data store, such as a registry 116, which includes one or more designation rules 119. The designation rules 119 are associated with designations and contain one or more transaction attributes that are compared with one or more transaction attributes in the transaction profiles 123. Each designations rule 119 is associated with one designation. The transaction categorization system 100 can compute match scores for each combination of transaction profile 123 and designation rule 119 based on the number of transaction attributes that match. If a designation rule 119 contains multiple transaction attributes, application of the designation rule may yield multiple attribute scores. The multiple attribute scores may be summed or averaged to yield an overall match score for the transaction.

The designation rule that yields the highest match score or a match score that meets a match criteria (e.g., exceeds a threshold) will be applied to the transaction and the transaction will be designated according to the designation rule. The transaction categorization server 101 repeats this process for all available transactions associated with the user 102 and generates a designated transactions report 125 that is sent to the user 102. Transactions where no designation rule 119 yields a match score that meets the match criteria or multiple designation rules 119 yield equal (or nearly equal) values are not designated in the designated transactions report 125 and are left for the user 102 to manually designate. Alternatively, the transaction categorization system 100 may provisionally designate such transactions but flag them for the user 102 to review later. The designated transactions report 125 is sent to the user 102 over the network 106 via wireline connection, wireless connection, or any combination thereof. The transaction designations may be categories, payee names, or any other designations that a user may make or want a PFM system to make to help organize and analyze the user's financial transactions.

The user may then review the designated transactions report 125 and optionally provide transaction report corrections 127 back to the transaction categorization server 101. In one implementation, the designated transactions report 125 may not contain all of the user's transactions. The user 102 may send the transaction categorization server 101 additional transaction profiles 123 as transaction report corrections 127 for designation and inclusion in the designated transactions report 125.

In another implementation, one or more transactions in the designated transactions report 125 may be lacking designation or mis-designated. The user 102 may send the transaction categorization server 101 corrected designations for mis-designated transactions and/or new designations for un-designated transactions. The transaction categorization system 100 may use the corrected and/or new designations to create new designation rules 119 or update existing designation rules 119 to correspond with the user's designation preferences. The corrected and/or new designations may be categories, payee names, or any other designations that a user may make or want a PFM system to make to help organize and analyze the user's financial transactions.

In yet another implementation, the transaction categorization system 100 may retroactively update previously designated transactions to be consistent with the user's corrected and/or new designations and corresponding corrected and/or new designation rules 119. This updating may be accomplished automatically or via a user prompt. The retroactively updated designations may be categories, payee names, or any other designations that a user may make or want a PFM system to make to help organize and analyze the user's financial transactions.

In yet another implementation, the user 102 may propose new designations and/or designation rules 119 associated with the new designations to be included in the transaction categorization system 100. The transaction categorization system 100 can either automatically incorporate the user's new designation rules 119 and/or designations or provide a reviewing process to test and approve the user's new designation rules 119 and/or designations. Further, if the user 102 merely provides a new designation without a corresponding designation rule 119, the transaction categorization system 100 can generate designation rules 119 for use with the new designation.

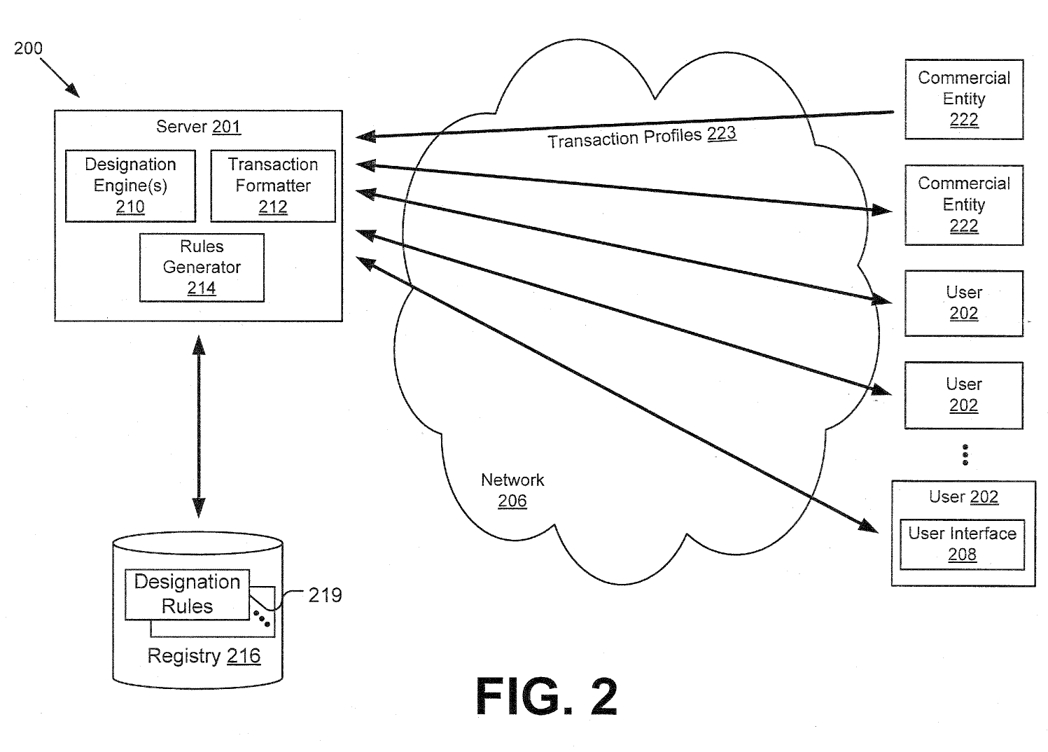

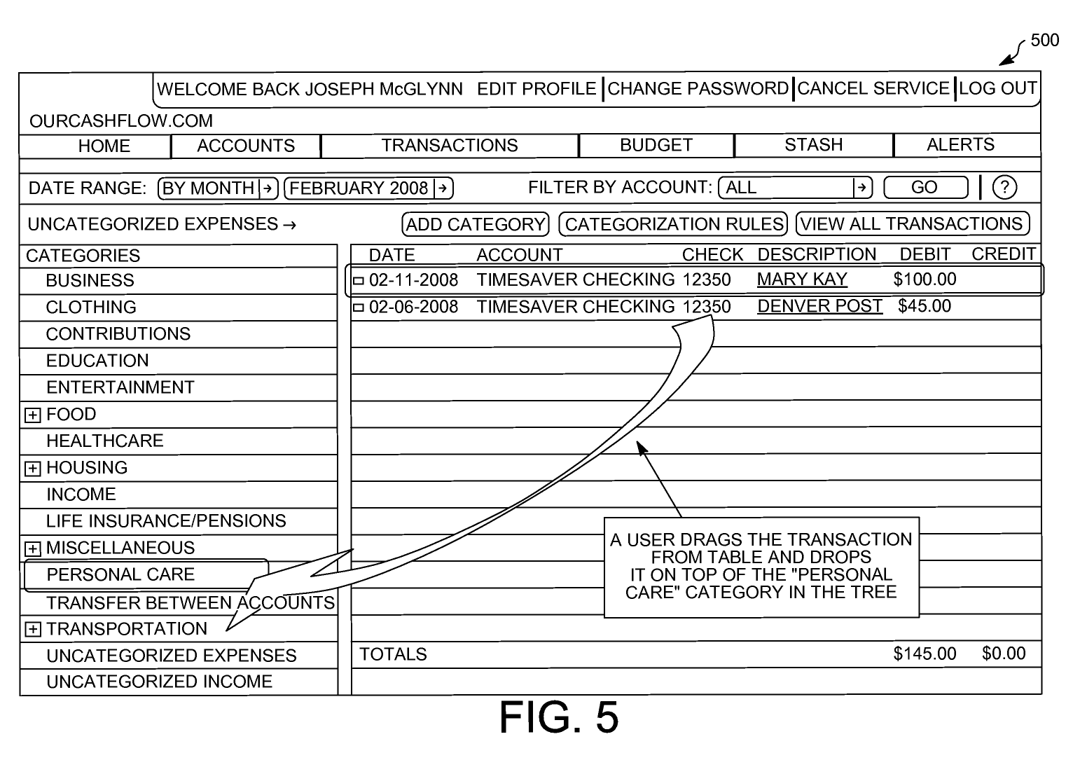

FIG. 2 illustrates an example transaction categorization system 200 with multiple users 202 and commercial entities 222 operating over a network 206 in accordance with one implementation of the presently disclosed technology. Users 202 interact with the transaction categorization system 200 via a communication network 206, which may be wireline, wireless, or any combination thereof. The users 202 each have a user interface 208 for interfacing with the transaction categorization server 201. Graphical user interfaces such as those shown in the screenshots of FIGS. 5-7 can be presented via user interfaces 208.

One or more commercial entities 222 (e.g., banks, stores, restaurants, etc.) may be in communication with the transaction categorization server 201. Commercial entities 222 may be sources of transaction profiles 223 that can be submitted to the transaction categorization server 201. Users 202 may also submit transaction profiles 223 to the transaction categorization server 201. Transaction profiles 223 include transaction attributes describing a transaction, including, but not limited to, payee name, transaction description, transaction date, transaction amount, transaction type code, account type, payment method, recurrence period, recurrence time, demographic information, match count, and select count.

The transaction categorization server 201 includes one or more designation engines 210, a transaction formatter 212, and a rules generator 214. The transaction categorization server 201 is in operable communication with a data store, such as registry 216, which includes one or more designation rules 219. The transaction formatter 212 formats incoming transaction profiles 223. In one implementation, the transaction formatter 212 derives transaction attributes based on the transaction profiles 223. Example transaction attributes are mentioned above.

The designation engine 210 correlates incoming transaction profiles 223 with designation rules 219. In various implementations, correlating a transaction profile 223 with a designation rule 219 involves determining the degree to which the associated transaction profile 223 corresponds to the designation rule 219. In one implementation, a transaction profile 223 is correlated with a designation rule 219 by correlating one or more of the transaction attributes with data in the designation rule 219, to yield attribute scores associated with each correlated transaction attribute. The attribute scores may be summed or averaged to generate an overall transaction match score. As a result, each match score is associated with a specific transaction and one of the designation rules 219.

The rules generator 214 generates designation rules 219 based on manual user transaction designation. The rules generator 214 monitors manual transaction designations of users to “learn” user-preferred designation rules 219. The rules generator 214 creates designation rules 219 that associate transaction attributes with specific transaction designations.

Some implementations of the transaction categorization system 200 may be viewed as “learning” designation strategies from users 202. Further, learned strategies can be applied to future transactions of the user 202 who created the strategy. Designation strategies can be automatically applied to transactions without requiring manual user designation. Alternatively or in addition, a user 202 may be prompted with a number of designations having matching scores according to designation rules 219. The user 202 may be prompted to manually select from the designations having matching scores.

According to one such implementation of the presently disclosed technology that “learns” designation strategies from users 202; financial transactions are formatted for the server 201 by the transaction formatter 212. Keywords and other transaction characteristics are “tagged” in each transaction profile 223 to create an “attribute set” for each transaction. The next step is for the transaction categorization system 200 is to “learn” how attribute sets are designated. As users 202 manually designate transactions, a rules generator 214 learns “target designations” for transactions with certain attributes. This trains the transaction categorization system 200, allowing it to very quickly start to create designation rules 219.

As transactions profiles 223 are collected by the server 201, corresponding attribute sets are presented to the rules generator 214. Once a certain level of confidence is reached through this learning process, the rules generator 214 will recommend a learned target designation for a transaction and the designation engine 210 will automatically designate the transaction.

When a transaction profile 223 is received by the server 201, the transaction attribute set is presented to the designation engine 210. If the designation engine 210 has learned how to designate a transaction profile 223 with this attribute set, the designation engine 210 uses the appropriate rule(s) to designate the transaction. If the designation engine 210 does not find a target designation with acceptable confidence, it will present the transaction to the user 202 for manual designation and learning. The designation engine 210 may select a narrowed group of designation suggestions for the transaction. For example, one user 202 may shop SEARS primarily for clothing, while another user 202 shops SEARS for power tools. In this case, the designation engine 210 will suggest both designations to the user 202 and learn which designation to use on future SEARS transactions based on the user's manual designation of the transaction.

The operating environments 100 and 200 shown in FIGS. 1 and 2 are simplified from actual operating environments for case of illustration. In an actual networked environment there may be many users 102, 202 and/or commercial entities 122, 222. In addition, the networks 106, 206 may be composed of many networks and/or sub-networks. For example, the networks 106, 206 may represent the Internet which includes numerous sub-networks. The network connections between the transaction categorization server 101, 201 and the users 102, 202 and/or commercial entities 122, 222 may be virtual private networks. Generally the connections are secure connections using any secure communication protocol known in the art.

Using common attributes of transactions such as, but not limited to, payee name, transaction description, transaction date, transaction amount, transaction type code, account type, payment method, recurrence period, recurrence time, demographic information, match count, and select count, the transaction categorization system 100, 200 can quickly learn how to designate transactions for spending analysis. The transaction categorization system 100, 200 automatically creates designation rules 219 for a user based on the user's initial manual designations as well as utilizing designation rules 219 defined by a system administrator.

Statistical categorization and machine learning techniques have been applied to unstructured data categorization, including multivariate regression models, Bayesian models, decision trees, neural networks, and symbolic rule learning. Most recently, Support Vector Machines (SVMs) for classification have been shown to learn faster and categorize more accurately than earlier methods. Some implementations described herein use an adapted version of SVM for providing transaction categorization functionality. Experiments conducted separately by Microsoft¹ and Joachims² found that SVM's categorized even the simplest document representation (using individual words delimited by white spaces with no stemming) accurately for up to 98% of the documents presented. The inventors have seen similar results in initial tests with an implementation of the presently disclosed transaction categorization system. Other implementations do not use an SVM, but rather a pattern matching—based approach. ¹Dumas et al for Microsoft, Inductive Learning Algorithms and Representations for Text Categorization, 1988.²Joachims, T. Text categorization with support vector machines: Learning with many relevant features. In Proceedings 10th European Conference on Machine Learning (ECML), Springer Verlag, 1998.

Implementations of a method and system for transaction categorization may use any existing and emerging unstructured data categorization approaches that support tasks as diverse as real-time sorting of new reports, spam filtering, hand writing recognition, structured search, and image classification. These data categorization approaches may be adopted and modified for financial transactions designation according to the presently disclosed technology. Attribute-based designation-the assignment of unstructured data and natural language text to one or more predefined designations based on the content-is a key component in taking the effort out of PFM administration according to the presently disclosed technology.

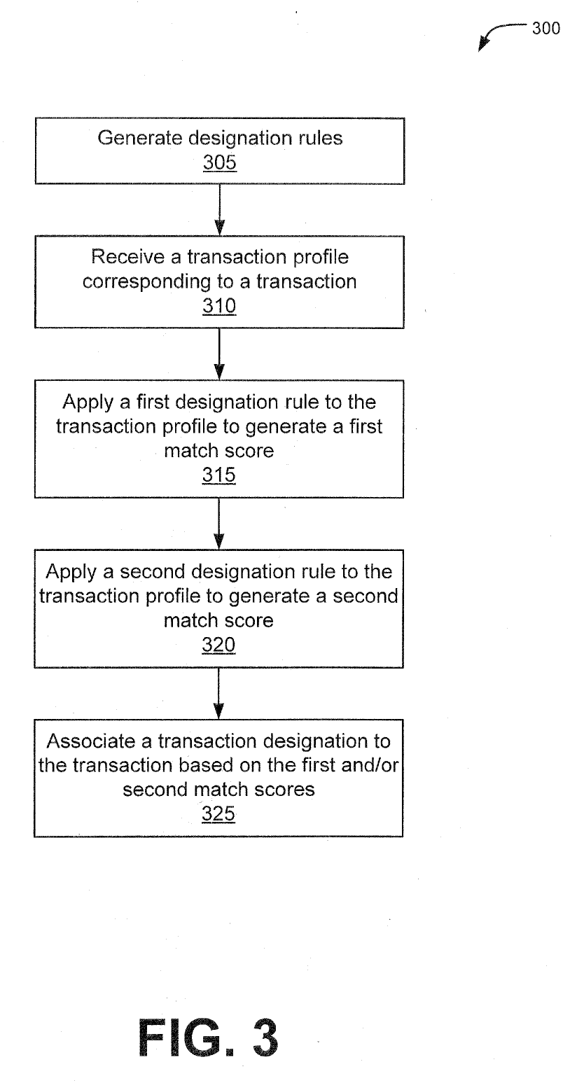

FIG. 3 is an attribute-based transaction categorization flowchart illustrating an algorithm for associating a transaction designation according to one implementation 300. The transaction categorization system first generates a set of designation rules relating transaction attributes to a plurality of financial transaction designations 305. The designation rules may be generated by a system administrator based on transaction attributes common to a transaction designation. Alternatively, the designation rules may be generated by a user and submitted to the system administrator for approval. The system administrator may automatically incorporate the user-defined designation rules or may utilize an approval and/or testing process before incorporating the user-defined rules. In another implementation, the user may manually designate a transaction. The system administrator can capture attributes of the manually designated transaction and generate a categorization rule associating one or more of the transaction attributes with the identified designation.

Next, the transaction categorization system receives a transaction profile corresponding to a transaction 310. The transaction profile includes transaction attributes, including, but not limited to payee name, transaction description, transaction date, transaction amount, transaction type code, account type, payment method, recurrence period, recurrence time, demographic information, match count, and select count. The transaction profile may be sent to the transaction categorization system from a commercial entity (e.g., a bank, store, restaurant, etc.) a user of the transaction categorization system.

The transaction categorization system applies a first designation rule to the transaction profile to generate a first match score 315. More specifically, applying the first designation rule may include generating one or more transaction attribute scores, each transaction attribute score being associated with an attribute of the transaction, and combining the transaction attribute scores to generate the first match score. Generating the first match score may include weighting each of the transaction attribute scores with a weight factor associated with the corresponding attribute and/or the degree to which each attribute matches a corresponding field of the first designation rule. Further, determining the first match score may include finding transaction attributes in the transaction profile that match at least one transaction attribute in the first designation rule. Similarly, the transaction categorization system may then apply a second designation rule to the transaction profile to generate a second match score 320.

Finally, the transaction categorization system associates a transaction designation to the transaction based on the first and/or second match scores 325. In one implementation, there is only one designation rule applied and thus only one match score calculated for a transaction. The transaction categorization system may compare the match score with a match criterion (such as a value threshold) to determine if the match is sufficient to associate a transaction designation to the transaction.

In another implementation where the first and second designation rules are naming rules and the transaction designation is a payee name, the transaction categorization system may further replace the contents of the payee field of the transaction profile with the payee name as specified by the first and/or second naming rule. In another implementation, the contents of the payee field may be blank and filled in with the payee name as specified by the first and/or second naming rule.

In another implementation, the method may include applying multiple designation rules, such as the first designation rule and the second designation rule, to the transaction to generate multiple match scores. The respective match scores are compared to one another to find the best match score. The match scores may also be compared with the match criterion to determine if either match is sufficient to associate a transaction designation to the transaction. An implementation of the method may further include applying the designation rules to one or more additional transactions.

Further, the method may include communicating the designation rule to a system administrator. Further still, the method may include adding the designation rule to a register of designation rules. Further yet, the method may include incrementing a match counter counting the number of times the designation rule has matched a transaction. Still further, the method may include incrementing a selection counter counting the number of times the designation rule has been selected.

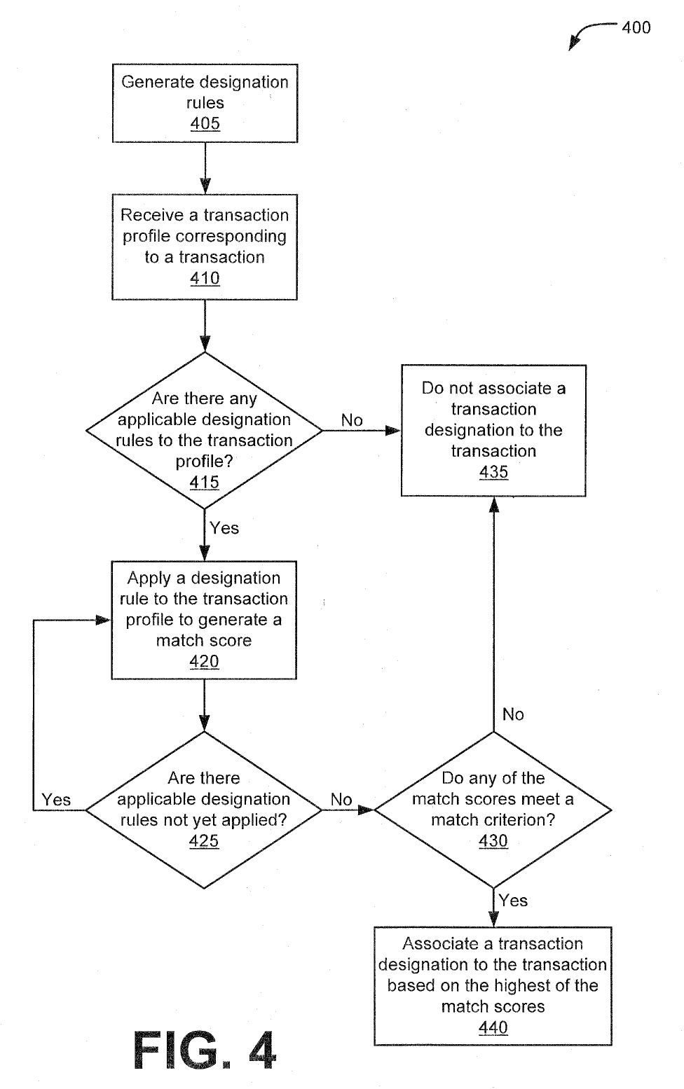

FIG. 4 is an attribute-based transaction categorization flowchart illustrating an algorithm for associating a transaction designation according to another implementation. Similar to the method of FIG. 3, the transaction categorization system first generates a set of designation rules relating transaction attributes to a plurality of financial transaction designations 405. Then, the transaction categorization system receives a transaction profile corresponding to a transaction 410.

The transaction categorization system then implements a query operation that determines if there are any applicable designation rules to the transaction profile 415. The transaction categorization system may require a transaction profile to share a minimum number of transaction attributes with the designation rule to apply the designation rule. If there are no applicable designation rules to the transaction profile, the system does not associate a transaction designation to the transaction and the method terminates 435.

If there are applicable designation rules, they are applied in succession 420 until the transaction categorization system determines that there are no more applicable designation rules not yet applied 425. For each designation rule, transaction attributes are iterated through and a transaction attribute score is generated for each transaction attribute. Further, the transaction attribute scores may be weighted. The resulting transaction attribute scores are combined (e.g. summed, averaged) to generate the match score for the rule applied to the transaction profile.

Once all the applicable designation rules are applied to the transaction profile, the resulting match scores are compared with a match criterion to determine if any of the match scores are sufficient to apply a transaction designation to the transaction 430. If none of the match scores are sufficient, the system does not associate a transaction designation to the transaction and the method terminates 435. Otherwise, the system associates a transaction designation to the transaction based on the highest of the match scores 440.

Implementations of the transaction categorization system include functional modules or engines for carrying out the method steps described herein. Implementations of computer-readable media have computer-executable instructions that, when executed, cause a computer to carry out method steps described herein.

Some implementations of the presently disclosed technology utilize a matching algorithm to determine the best fit designation for an individual transaction. The algorithm generates a match score for a transaction with respect to each applicable designation rule. This process may be performed iteratively through all the designation rules. After the transaction has been evaluated against all designation rules, the designation rule that generates the best match score is utilized to associate a transaction designation to the transaction. In one implementation, the best match score must satisfy a match criterion (e.g. exceed a confidence threshold) to be considered applicable. If the best match score satisfies the match criterion, then the transaction will be designated according to the designation rule. If the best match score does not satisfy the match criterion, then the transaction will remain undesignated.

The scoring of a designation rule against the transaction is performed by combining (e.g. summing, averaging) individual scores on transaction attributes (e.g. textual, non-textual, and non-transactional) with a configurable weight applied to each attribute. The weighting enables specific attributes to contribute more or less to the match score.

Example textual transaction attributes that may be used in the scoring include, but are not limited to, payee name, transaction description, and any other words that directly describe the transaction. Payee name refers to the name of the entity with whom a user made a transaction. Transaction description refers to a description that the user may assign to the transaction at the time the transaction took place, e.g., the contents of the memo field of a paper check.

Further, non-textual transaction attributes (e.g. numeric information) may also be used in the scoring, including, but not limited to, transaction date, transaction amount, transaction type code, account type, payment method, recurrence period, and recurrence time. Transaction date refers to the date upon which the user made the transaction with the payee. Transaction amount refers to the amount of the transaction between the user and the payee. Transaction type code refers to a code assigned to a transaction that identifies the nature, purpose, and/or reason of the transaction, primarily used for regulatory reporting requirements. Account type refers to the user's funding source account for the transaction. Example account types include, but are not limited to, checking, savings, money market, credit card, and loan. Payment method refers to the type of payment used for the transaction. Example payment methods include, but are not limited to, cash, credit, and debit. Recurrence period refers to the period in which a transaction recurs. For example, rent is typically paid monthly and taxes are typically paid yearly. Additionally, recurrence time refers to the time of the week, month, and year, etc. in which a transaction recurs. For example, rent is typically paid at the beginning of each month and taxes are typically paid in April each year.

Additionally, non-transaction attributes may also be used in the scoring, including, but not limited to, demographic information, match count, select count, and any other information that may be used to associate transaction designations that does not relate to a specific transaction itself. Demographic information includes, but is not limited to race, sex, age, income, disabilities, mobility, education, home ownership, employment status, and location. Match count refers to the number of transactions, previously applied to a designation rule, that meet the requirements of the designation rule. Select count refers to the number of matched transactions, previously applied to a designation rule, that are actually categorized as the designation rule suggests. A combination of match count and select count is referred to as a confidence score.

As discussed above, the presently disclosed technology contemplates both static and dynamic designations. While categories and transaction names are described with particularly herein, any static designation associated with a designation rule may be used to designate a transaction.

Further, the presently disclosed technology contemplates dynamic designations. A dynamic designation is not a fixed designation for a financial transaction but rather a pointer to a way of revising an aspect of a financial transaction. For example, a dynamic designation may point to a look up table for modifying an aspect of the transaction. In another example, a dynamic designation may point to a formula for cleansing the payee field of a financial transaction.

An implementation of a dynamic designation function checking for a best match using the payee name in a transaction profile is described below. This implementation utilizes a pattern generation and matching process rather than an SVM. Various parts of the following process are carried out by the modules and engines of the transaction categorization server 201 as shown in FIG. 2.

In this implementation, when a user manually designates a transaction, a designation rule is created that contains a payee name cleansing function for the payee name attribute field. This function is used for scoring the payee name attribute of the transaction. For example, an incoming transaction profile may have “The Chop House #1234 (29856)” in the payee name attribute field. The payee name cleansing function may be designed to: 1) truncate all characters from the payee name field after the occurrence of “(“; 2) truncate all characters from the payee name field after the occurrence of “<”; 3) truncate all characters from the payee name field after the occurrence of “′”; and/or 4) remove all dangling meta characters (e.g., replaces occurrences of “**” with “*”) from the payee name field.

The resulting pattern will then consist of one or more tokens. Here, the resulting pattern is “The Chop House #1234” and is composed of 4 tokens. Individual tokens in the payee name field are then omitted if they meet certain conditions. For example, the function may omit tokens if: 1) the token is only 1 character in length; 2) the token is one of the following: AND, OR, IS, OF, BY, THE, THIS, THAT, TO, FROM; and/or 3) the token consists of only numbers (e.g., 1234 or #1234).

The resulting pattern may then join the tokens with a “.*” between them to support the technique of using regular expressions (regex) within a Java Pattern class to determine a match. In the above example, the resulting pattern that is generated is “The.*Chop.*House.*”. Similarly, the cleansing function maybe applied to any transaction attribute filed that contains a string of words. As a result, when an incoming transaction profile has a payee name that matches a designation rule, after the payee name cleaning function is applied, a weighted score is applied for the payee name attribute field to the overall match score for the designation rule.

FIG. 5 is a screenshot of an example user interface for use in an attribute-based transaction categorization system according to various implementations of the presently disclosed technology. The user is presented with a list of expense categories on the left-hand side of the computer screen. These expense categories may have subcategories, sub-subcategories, and so on. The user is also presented with a list of uncategorized transactions with various transaction attributes associated with each transaction. Here, each transaction is accompanied with a transaction date, funding account, check number, transaction description, and amount. Further, the list of uncategorized transactions may be filtered to a date range or funding account.

The list of uncategorized transactions comprises transactions that the transaction categorization system does not yet know how to categorize. For example, the first time a transaction is input with a MARY KAY description attribute, the transaction categorization system may not know how to categorize the transaction. Thus the MARY KAY transaction is listed as uncategorized. The user may then manually select a category for this MARY KAY transaction. This selection may be made by any means of computer input; however, here the input is made by a “drag-and-drop” operation. The MARY KAY transaction is “dragged” from the uncategorized expenses list and “dropped” in the “Personal Care” category. To assist with this initial classification, the transaction categorization system may create a categorization rule to group transactions based on common attributes. For example, if the uncategorized expenses list contained multiple MARY KAY transactions, dragging and dropping one MARY KAY transaction in the “Personal Care” category may cause all the MARY KAY transactions to automatically move to the “Personal Care” category. Alternatively, the transaction categorization system may prompt the user asking if it should classify all MARY KAY as “Personal Care.” The system may move only MARY KAY transactions that are not yet categorized, or alternatively, the system may retroactively re-categorize MARY KAY transactions according to the new system created rule. A user can thus very quickly categorize multiple similar transactions not yet learned by the application.

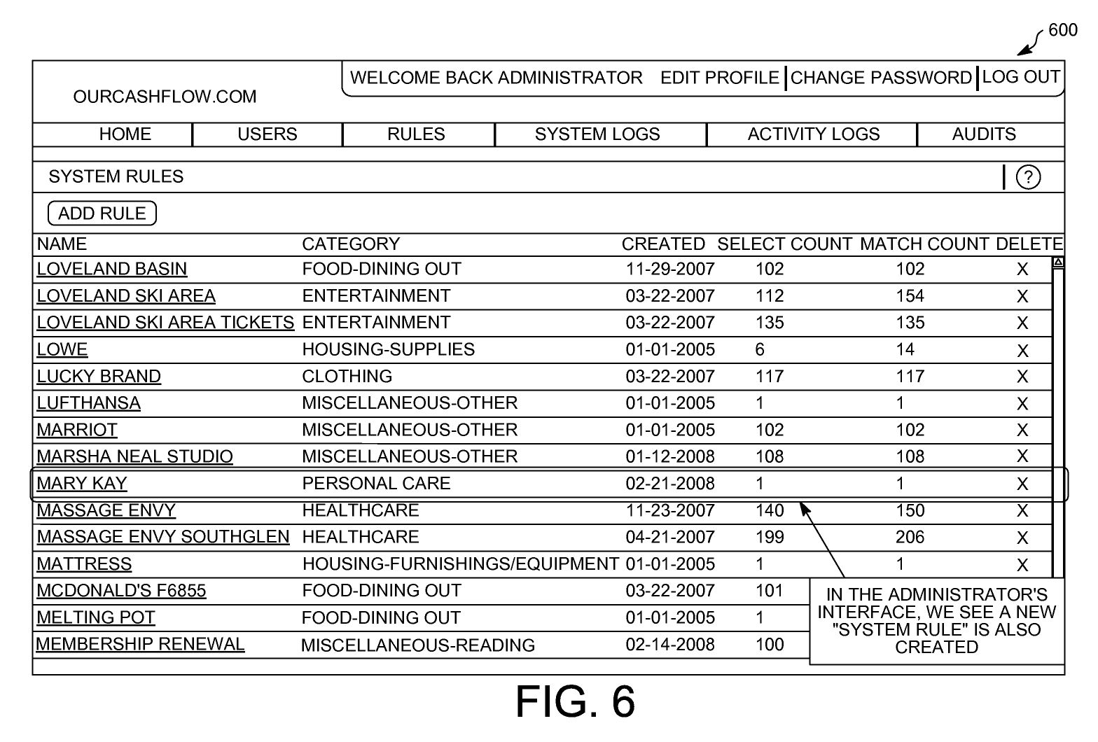

Referring now to FIG. 6, an administrator interface is shown. In the “Rules” section of the administrator interface, a list of system rules is shown. The system rules are listed by description and associated category along with a date created. The system rules also show statistics such as SELECT COUNT and MATCH COUNT. MATCH COUNT indicates the number of transactions that meet the requirements of the rule. SELECT COUNT indicates the number of matched transactions that are actually categorized as the rule suggests. The reason that the SELECT COUNT is less than the MATCH COUNT in some transaction descriptions (e.g. LOVELAND SKI AREA and MASSAGE ENVY) is due to manual categorization overriding the categorization rule or another categorization rule with a higher match score overriding the categorization rule with a lower match score. Referring to the MARY KAY rule, the system rule indicates that there is one MATCH COUNT and one SELECT COUNT showing that the user rule created in FIG. 5 is the only rule referencing MARY KAY and is applied in only one instance.

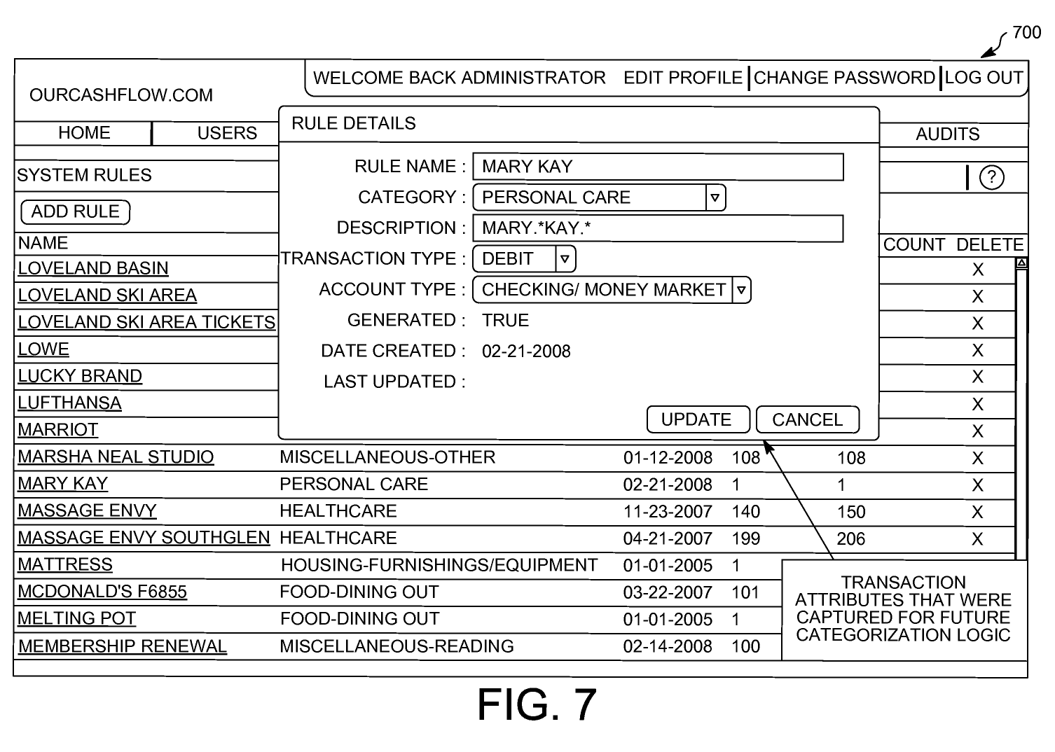

Further, the Administrator may select a specific system rule to view more information. In FIG. 6, the Administrator has selected MARY KAY to view additional information shown in FIG. 7. Referring now to FIG. 7, the description, MARY KAY, has been adopted as the rule name. The corresponding category, Personal Care is also shown along with the description, transaction type, funding account type, a generated field, the date created, and date the rule was last updated. A selection is available for the Administrator to update one or more categorization parameters for the system rule. The categorization parameters shown are examples only, additional categorization parameters include but are not limited to: payee name, transaction description, transaction date, transaction amount, transaction type code, account type, payment method, recurrence period, recurrence time, demographic information, match count, and select count.

After a short learning cycle, the system has the confidence to categorize all MARY KAY transactions as “Personal Care.” For example, even transactions with no description may be classified using other attributes including but not limited to payee name, amount of the transaction, and time of month when it is paid to learn categories.

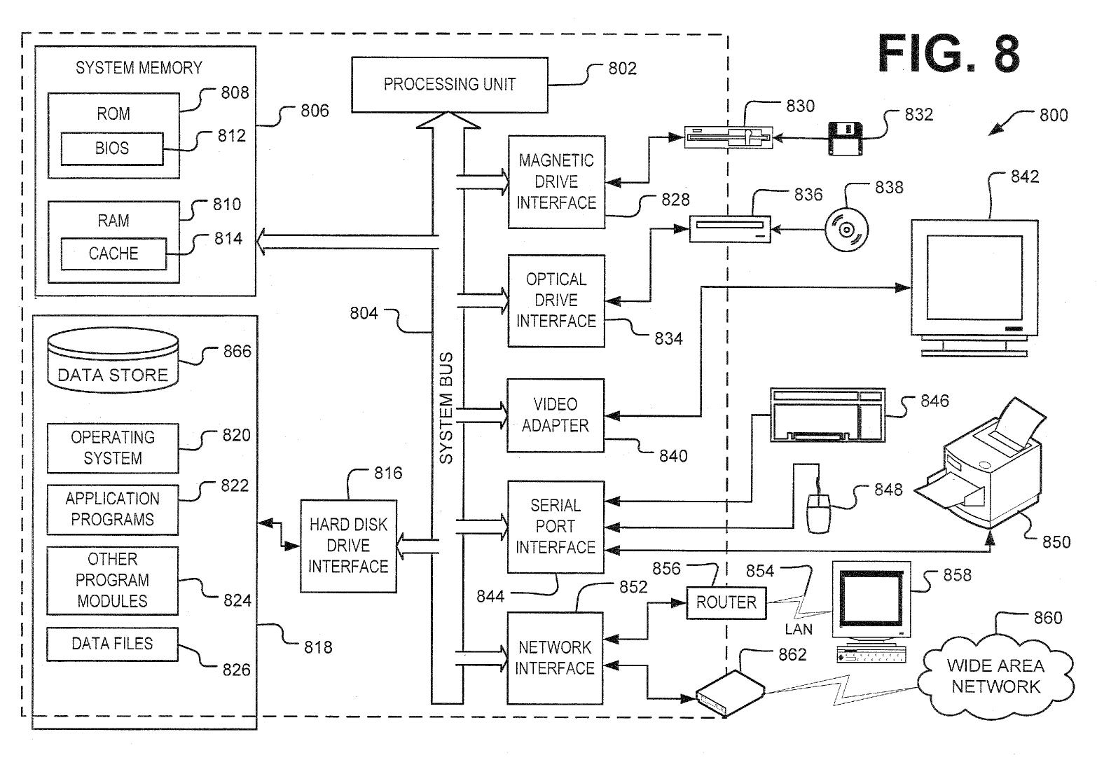

An example computer system 800 for implementing the matching, designating, categorizing, and naming processes above is depicted in FIG. 8. The computer system 800 may be in the form of server computers, personal computers (PC), or other special purpose computers with internal processing and memory components as well as interface components for connection with external input, output, storage, network, and other types of peripheral devices. Alternatively, the computer system 800 may be in the form of any of a notebook or portable computer, a tablet PC, a handheld media player (e.g., an MP3 player), a smart phone device, a video gaming device, a set top box, a workstation, a mainframe computer, a distributed computer, an Internet appliance, or other computer devices, or combinations thereof. Internal components of the computer system in FIG. 8 are shown within the dashed line and external components are shown outside of the dashed line. Components that may be internal or external are shown straddling the dashed line.

The computer system 800 includes a processor 802 and a system memory 806 connected by a system bus 804 that also operatively couples various system components. There may be one or more processors 802, e.g., a single central processing unit (CPU), or a plurality of processing units, commonly referred to as a parallel processing environment. The system bus 804 may be any of several types of bus structures including a memory bus or memory controller, a peripheral bus, a switched-fabric, point-to-point connection, and a local bus using any of a variety of bus architectures. The system memory 806 includes read only memory (ROM) 808 and random access memory (RAM) 810. A basic input/output system (BIOS) 812, containing the basic routines that help to transfer information between elements within the computer system 800, such as during start-up, is stored in ROM 808. A cache 814 may be set aside in RAM 810 to provide a high speed memory store for frequently accessed data.

A hard disk drive interface 816 may be connected with the system bus 804 to provide read and write access to a data storage device, e.g., a hard disk drive 818, for nonvolatile storage of applications, files, and data. A number of program modules and other data may be stored on the hard disk 818, including an operating system 820, one or more application programs 822, other program modules 824, and data files 826. In an example implementation, the hard disk drive 818 may further store a registry of categorization rules and its corresponding modules. The hard disk drive 818 may additionally contain a data store 866 for maintaining the success and failure tables and other database server information described above. Note that the hard disk drive 818 may be either an internal component or an external component of the computer system 800 as indicated by the hard disk drive 818 straddling the dashed line in FIG. 8. In some configurations, there may be both an internal and an external hard disk drive 818.

The computer system 800 may further include a magnetic disk drive 830 for reading from or writing to a removable magnetic disk 832, tape, or other magnetic media. The magnetic disk drive 830 may be connected with the system bus 804 via a magnetic drive interface 828 to provide read and write access to the magnetic disk drive 830 initiated by other components or applications within the computer system 800. The magnetic disk drive 830 and the associated computer-readable media may be used to provide nonvolatile storage of computer-readable instructions, data structures, program modules, and other data for the computer system 800.

The computer system 800 may additionally include an optical disk drive 836 for reading from or writing to a removable optical disk 838 such as a CD ROM or other optical media. The optical disk drive 836 may be connected with the system bus 804 via an optical drive interface 834 to provide read and write access to the optical disk drive 836 initiated by other components or applications within the computer system 800. The optical disk drive 830 and the associated computer-readable optical media may be used to provide nonvolatile storage of computer-readable instructions, data structures, program modules, and other data for the computer system 800.

A display device 842, e.g., a monitor, a television, or a projector, or other type of presentation device may also be connected to the system bus 804 via an interface, such as a video adapter 840 or video card. Similarly, audio devices, for example, external speakers or a microphone (not shown), may be connected to the system bus 804 through an audio card or other audio interface (not shown).

In addition to the monitor 842, the computer system 800 may include other peripheral input and output devices, which are often connected to the processor 802 and memory 806 through the serial port interface 844 that is coupled to the system bus 806. Input and output devices may also or alternately be connected with the system bus 804 by other interfaces, for example, a universal serial bus (USB), a parallel port, or a FireWire (IEEE 894) port. A user may enter commands and information into the computer system 800 through various input devices including, for example, a keyboard 846 and pointing device 848, for example, a mouse. Other input devices (not shown) may include, for example, a microphone, a joystick, a game pad, a tablet, a touch screen device, a satellite dish, a scanner, a facsimile machine, and a digital camera, and a digital video camera. Other output devices may include, for example, a printer 850, a plotter, a photocopier, a photo printer, a facsimile machine, and a press (the latter not shown). In some implementations, several of these input and output devices may be combined into a single device, for example, a printer/scanner/fax/photocopier. It should also be appreciated that other types of computer-readable media and associated drives for storing data, for example, magnetic cassettes or flash memory drives, may be accessed by the computer system 800 via the serial port interface 844 (e.g., USB) or similar port interface.

The computer system 800 may operate in a networked environment using logical connections through a network interface 852 coupled with the system bus 804 to communicate with one or more remote devices. The logical connections depicted in FIG. 8 include a local-area network (LAN) 854 and a wide-area network (WAN) 860. Such networking environments are commonplace in home networks, office networks, enterprise-wide computer networks, and intranets. These logical connections may be achieved by a communication device coupled to or integral with the computer system 800. As depicted in FIG. 8, the LAN 854 may use a router 856 or hub, either wired or wireless, internal or external, to connect with remote devices, e.g., a remote computer 858, similarly connected on the LAN 854. The remote computer 858 may be another personal computer, a server, a client, a peer device, or other common network node, and typically includes many or all of the elements described above relative to the computer system 800.

To connect with a WAN 860, the computer system 800 typically includes a modem 862 for establishing communications over the WAN 860. Typically the WAN 860 may be the Internet. However, in some instances the WAN 860 may be a large private network spread among multiple locations. The modem 862 may be a telephone modem, a high speed modem (e.g., a digital subscriber line (DSL) modem), a cable modem, or similar type of communications device. The modem 862, which may be internal or external, is connected to the system bus 818 via the network interface 852. In alternate implementations the modem 862 may be connected via the serial port interface 844. It should be appreciated that the network connections shown are examples and other means of and communications devices for establishing a communications link between the computer system and other devices or networks may be used. Connection of the computer system 800 with a LAN 854 or WAN 860 allows an intelligent categorization application the ability to communicate with an administrator or remote community-based budgeting application similarly connected to the LAN 854 or WAN 860 to apply privately developed categorization rules to transactions generated by others in the community.

In an example implementation, a designation engine, transaction formatter, rules generator, and other modules may be embodied by instructions stored in memory 806 and/or storage devices 832 or 838 and processed by the processing unit 802. Designation rules, transaction profiles, designated transactions reports, transaction report corrections, and other data may be stored in memory 806 and/or storage devices 832 or 838 as persistent datastores.

Although various implementations of presently disclosed technology have been described above with a certain degree of particularity, or with reference to one or more individual implementations, those skilled in the art could make numerous alterations to the disclosed implementations without departing from the spirit or scope of the presently disclosed technology. All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the presently disclosed technology, and do not create limitations, particularly as to the position, orientation, or use of the presently disclosed technology. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the basic elements of the presently disclosed technology.

What is claimed is:

1. A method of categorizing a financial transaction, the method comprising:
generating a set of designation rules, each designation rule relating a plurality of transaction attributes to a financial transaction designation;
receiving first transaction attributes specific to the financial transaction;
applying a first designation rule to the first transaction attributes to generate a first match score;
associating a selected financial transaction designation with the financial transaction if the first match score satisfies a match criterion.

2. The method of claim 1, further comprising:
applying a second designation rule to the first transaction attributes to generate a second match score; and
wherein the associating operation comprises:
selecting a first financial transaction designation as the selected financial transaction designation, if the first match score satisfies a match criterion; and
selecting a second transaction designation as the selected financial transaction designation, if the second match score satisfies the match criterion.

3. The method of claim 1, wherein the first transaction attributes include non-textual attributes associated with the financial transaction.

4. The method of claim 1, wherein the first transaction attributes include non-transaction attributes associated with a user.

5. The method of claim 1, wherein the first transaction attributes are selected from a group comprising: transaction date, transaction amount, transaction type code, account type, payment method, recurrence period, recurrence time, demographic information, match count, and select count.

6. The method of claim 1, wherein the first designation rule is a categorization rule and the financial transaction designation represents a transaction category.

7. The method of claim 1, wherein the first designation rule is a naming rule and the financial transaction designation represents a payee name.

8. The method of claim 1, wherein the financial transaction designation indicates a designation function, further comprising
executing the designation function to modify contents of a payee field of the financial transaction to generate a revised payee name; and
replacing the contents of the payee field with the revised payee name.

9. The method of claim 1, further comprising:
receiving a user defined designation for the financial transaction if the first match score does not satisfy the match criterion; and
generating a second designation rule based on transaction attributes of the financial transaction and the user defined designation.

10. The method of claim 1, further comprising:
re-designating previously designated financial transactions based on the first designation rule.

11. A computer-readable storage medium having computer-executable instructions for performing a computer process for categorizing financial transactions, the computer process comprising:
generating a set of designation rules relating transaction attributes to a plurality of financial transaction designations;
receiving first transaction attributes specific to the financial transaction;
applying a first designation rule to the first transaction attributes to generate a first match score;
associating a financial transaction designation with the financial transaction based on the first match score.

12. The computer-readable storage medium of claim 11, the computer process further comprising:
applying a second designation rule to the first transaction attributes to generate a second match score; and
wherein the associating operation comprises:
selecting a first financial transaction designation as the selected financial transaction designation, if the first match score satisfies a match criterion; and
selecting a second transaction designation as the selected financial transaction designation, if the second match score satisfies the match criterion.

13. The computer-readable storage medium of claim 11, wherein the first transaction attributes include non-textual attributes associated with the financial transaction.

14. The computer-readable storage medium of claim 11, wherein the first transaction attributes include non-transaction attributes associated with a user.

15. The computer-readable storage medium of claim 11, wherein the first transaction attributes are selected from a group comprising: transaction date, transaction amount, transaction type code, account type, payment method, recurrence period, recurrence time, demographic information, match count, and select count.

16. The computer-readable storage medium of claim 11, wherein the first designation rule is a categorization rule and the financial transaction designation represents a transaction category.

17. The computer-readable storage medium of claim 11, wherein the first designation rule is a naming rule and the financial transaction designation represents a payee name.

18. The computer-readable storage medium of claim 11, wherein the financial transaction designation indicates a designation function, the computer process further comprising
executing the designation function to modify contents of a payee field of the financial transaction to generate a revised payee name; and
replacing the contents of the payee field with the revised payee name.

19. The computer-readable storage medium of claim 11, the computer process further comprising:
receiving a user defined designation for the financial transaction if the first match score does not satisfy the match criterion; and
generating a second designation rule based on transaction attributes of the financial transaction and the user defined designation.

20. The computer-readable storage medium of claim 11, the computer process further comprising:
re-designating previously designated financial transactions based on the first designation rule.

21. A system for categorizing financial transactions, the system comprising:
one or more storage media that stores a set of designation rules, each designation rule relating a plurality of transaction attributes to a financial transaction designation;
a network interface that receives first transaction attributes specific to the financial transaction;
a processor that applies a first designation rule to the first transaction attributes to generate a first match score and associates a selected financial transaction designation with the financial transaction if the first match score satisfies a match criterion.

22. The system for categorizing financial transactions of claim 21, wherein the processor further applies a second designation rule to the first transaction attributes to generate a second match score; and
the processor associates the selected financial transaction designation by
selecting a first financial transaction designation as the selected financial transaction designation, if the first match score satisfies a match criterion; and
selecting a second transaction designation as the selected financial transaction designation, if the second match score satisfies the match criterion.

23. The system for categorizing financial transactions of claim 21, wherein the first transaction attributes include non-textual attributes associated with the financial transaction.

24. The system for categorizing financial transactions of claim 21, wherein the first transaction attributes include non-transaction attributes associated with a user.

25. The system for categorizing financial transactions of claim 21, wherein the first transaction attributes are selected from a group comprising: transaction date, transaction amount, transaction type code, account type, payment method, recurrence period, recurrence time, demographic information, match count, and select count.

26. The system for categorizing financial transactions of claim 21, wherein the first designation rule is a categorization rule and the financial transaction designation represents a transaction category.

27. The system for categorizing financial transactions of claim 21, wherein the first designation rule is a naming rule and the financial transaction designation represents a payee name.

28. The system for categorizing financial transactions of claim 21, wherein the financial transaction designation indicates a designation function and wherein the processor further
executes the designation function to modify contents of a payee field of the financial transaction to generate a revised payee name; and
replaces the contents of the payee field with the revised payee name.

29. The system for categorizing financial transactions of claim 21, wherein the network server receives a user defined designation for the financial transaction if the first match score does not satisfy the match criterion; and
the processor further generates a second designation rule based on transaction attributes of the financial transaction.

30. The system for categorizing financial transactions of claim 21, wherein the processor further re-designates previously designated financial transactions based on the first designation rule.
